(19) United States
(12) Patent Application Publication
(10) Pub. No.: US 2015/0040865 A1
(43) Pub. Date: Feb. 12, 2015

(54) METHOD AND DEVICE FOR OPERATING ENGINE SYSTEMS HAVING AN INTERNAL COMBUSTION ENGINE DURING MODE SWITCHING

(71) Applicants: Sven MERKLE, Stuttgart (DE); Matthias PFAU, Meiningen (DE); Matthias SIMONS, Stuttgart (DE); Andreas BETHMANN, Leonberg (DE); Stefan GOTTLIEB, Hemmingen (DE); Stephan von Adrian-Werburg, Stuttgart (DE); Benedikt TACKE, Stuttgart (DE)

(72) Inventors: Sven MERKLE, Stuttgart (DE); Matthias PFAU, Meiningen (DE); Matthias SIMONS, Stuttgart (DE); Andreas BETHMANN, Leonberg (DE); Stefan GOTTLIEB, Hemmingen (DE); Stephan von Adrian-Werburg, Stuttgart (DE); Benedikt TACKE, Stuttgart (DE)

(73) Assignee: Robert Bosch GmbH, Stuttgart (DE)

(21) Appl. No.: 14/450,915

(22) Filed: Aug. 4, 2014

(30) Foreign Application Priority Data
Aug. 8, 2013 (DE) 10 2013 108 580.6

(51) Int. Cl. F02P 5/155

(52) U.S. Cl. CPC F02P 5/1553
USPC 123/406.23

(57) ABSTRACT

In a method for adapting a torque model for operating an internal combustion engine, which torque model indicates an ignition angle adjustment as a function of an air charge in a cylinder of the internal combustion engine, the torque model is adapted based on a variation of an operating variable of the internal combustion engine caused by a mode switching.

### BACKGROUND OF THE INVENTION

1. Field of the Invention

The present invention relates in general to the field of internal combustion engines, particularly adaptation methods relating to torque model corrections during the service life of the internal combustion engine.

2. Description of the Related Art

Internal combustion engines operated using an ignition device, especially Otto engines, are controlled with the aid of a torque model. The entire structure of the torque model is based on a specified driver command torque, which the driver usually specifies via the accelerator. From the driver command torque, a setpoint charging is calculated via a suitable functional structure, which prescribes the desired air quantity in a cylinder per power stroke. Starting from the setpoint charging, all further parameters for operating the internal combustion engine, such as the ignition angle, the injection quantity, the camshaft position and the like may be ascertained according to the driver command torque specified.

In the running operation of the internal combustion engine, because of the operating mode change, situations may occur which may lead to a sudden change in the actual charging in the cylinders, which is not yielded by the torque structure. As a rule, without correcting interventions, such a sudden change in charging leads to a sudden torque change which has to be compensated for by an intervention via an adjustment of an ignition angle, since otherwise the travel comfort will be impaired by a jerking motion. The appropriate compensation is calculated using the torque model, which is applied, however, once per engine generation and, as a rule, cannot be adapted to specific engines. This means that, in the case of engine-specific deviations of the modeled engine torque from the actual engine torque, no adaptation takes place of the model in driving operation.

Because of engine-specific mass-production tolerances or changes of properties of the internal combustion engine during its service life, for example, based on changing tolerances, if changes in the charge motion, the combustion behavior and the like take place, the compensation by adaptation of the setpoint ignition angle is not carried out in an optimal manner. Especially during mode switching, in which the engine torque is to be held constant via an ignition angle intervention, this leads to torque deviations which may be perceptible to the driver in the form of jerking.

### BRIEF SUMMARY OF THE INVENTION

According to the present invention, a method is provided for adapting a torque model for operating an internal combustion engine, in which the torque model indicates an ignition angle adjustment as a function of an air charge in a cylinder of the internal combustion engine, the torque model being adapted based on a variation of an operating variable of the internal combustion engine caused by a mode switching.

The torque model, which is usually applied for charge-based internal combustion engines, is used to specify a setpoint air charge to be set by a regulation, as a function of a specified setpoint torque of the internal combustion engine. In addition, in the case of charging deviations of the actual charging from a specified setpoint charging, the torque model provides compensating for the efficiency of the internal combustion engine by adjusting the ignition angle, particularly by an ignition retard of the ignition angle. The adjustment of the ignition angle may be based, for example, on an efficiency characteristic curve, which gives an engine efficiency as a function as a function of an ignition angle, depending upon the operating point. If there are parameter deviations of the internal combustion engine, the efficiency characteristic curve will not agree with the actual circumstances of the internal combustion engine.

One idea of the above method is to undertake an adaptation of the torque model. The adaptation of the torque model takes place as a function of a difference between an engine torque before (the beginning) of a mode switching and an engine torque during and/or after a mode switching, in which a compensation is undertaken based on the existing torque model. If the adaptation of the ignition angle specified by the torque model for the compensation for the change in the engine torque effected by a sudden change in charging is not sufficient to keep the engine torque constant over a mode switching, an adaptation of the torque model is required.

Information on engine torques present before, during and after the mode switching may be derived with the aid of operating variables of the internal combustion engine, such as from the rotational speed, the rotational speed gradient and the like, since a lesser or a greater torque leads to a deceleration or an acceleration of the vehicle. Furthermore, such an operating variable may also be a variable which indicates the slipping of an automatic transmission, since changes in engine torques are able to lead to an increase or a decrease in the slipping. In this way, the torque model may be adapted during the running operation of the internal combustion engine, as soon as a mode switching has been concluded and a non-requested change in the drive torque given off to the drive wheel has been detected. Because of this, the aim that, before, during and after the mode switching, the same drive torque has to be provided, may be used for an adaptation of the torque model.

Moreover, the torque model is able to be calculated with the aid of an efficiency characteristic curve or be based on it, the efficiency characteristic curve being adjustable with the aid of a correction variable. The correction variable may be determined or adjusted based on a curve of an operating variable of the internal combustion engine in a first time period before a mode switching and a curve of the operating variable of the internal combustion engine in a further time period during and/or after a mode switching.

In particular, for the adaptation, mode switchings are used, in which the operation of the internal combustion engine is carried out before, during and after the time of the switching, based on the same torque model, as well as mode switchings in which before, during and after the time of the switching, different torque models are carried out which provide for an adaptation of the efficiency by an ignition angle adjustment. In the case of such a mode switching, if a sudden change in charging occurs, the mode switching is compensated for according to the existing torque model by an adaptation of the efficiency characteristic curve, which describes the efficiency based on a change in the ignition angle. In other words, this correction of the efficiency characteristic curve may be adapted as a function of evaluations of drive torque changes after mode switchings have taken place.

Furthermore, the correction variable, as a function of the operating point, is able to act upon an offset, an upgrade or individual characteristic map points of the efficiency characteristic curve of the torque model.

According to one specific embodiment, the operating variable is able to correspond to a state variable, in particular a rotational speed, a rotational speed gradient or a measure of the transmission slipping of an automatic transmission.

Furthermore, by extrapolation of the curve of the operating variable of the internal combustion engine, a first comparative variable may be determined in the first time period at a specified time, particularly the switching time of the switching of the mode, and a second comparative variable may be determined from the curve of the operating variable of the internal combustion engine in the further time period, particularly the maximum and/or the minimum value of the operating variable in the further time period, the correction variable being determined or adapted based on the first and the second comparative variable.

It may be provided that the adaptation of the correction variable is carried out with respect to the operating point, during the mode switching, as a function of a comparative variable difference as the difference between the first and the second comparative variable, in particular, as a function of whether the comparative variable difference exceeds a specified absolute value of the deviation.

The correction variable may be incremented or decremented, with respect to the operating point, as a function of the comparative variable difference by a constant value or by a value that is a function of the comparative variable difference.

Furthermore, an operating point-dependent adaptation characteristic map may be provided which is updated using a determined comparative variable difference at a certain operating point, by changing the values previously recorded and assigned to the certain operating point of comparative variable differences as a function of the determined comparative variable difference at the certain operating point, especially by updating the characteristic map point assigned to the certain operating point using a value which is yielded by the current value of the comparative variable difference at the certain operating point and the up-to-the-present value at the characteristic map point, the correction variable that is a function of the operating point being determined as a function of the respective characteristic map point of the adaptation characteristic map, or being yielded by it.

According to one specific embodiment, the mode switching may correspond to a switching between two operating modes which effects a charging change, both operating modes providing the adaptation of an efficiency by the adaptation of the ignition angle.

According to a further aspect, a device is provided, particularly a control unit, for adapting a torque model for operating an internal combustion engine, in which the torque model indicates an ignition angle adjustment as a function of an air charge in a cylinder of the internal combustion engine, the device being developed to adapt the torque model based on a variation of an operating variable of the internal combustion engine caused by a mode switching.

According to another aspect, a computer program product is provided, which includes a program code which implements all the steps of the above method when it is executed on a data processing unit or the above control unit.

### BRIEF DESCRIPTION OF THE DRAWINGS

FIG. 1 shows a schematic representation of an engine system having an internal combustion engine, which is actuated according to a torque model.

FIG. 2 shows a functional diagram for illustrating the torque model and for adapting the torque model.

FIG. 3 shows a diagram to represent the efficiency characteristic curve, which represents the engine efficiency plotted against the ignition angle.

FIG. 4 shows a flow chart to illustrate the method for adapting the torque model.

FIG. 5 shows a diagram for representing curves of operating variables of the internal combustion engine before, during and after a mode switching in response to a positive sudden change in charging.

FIG. 6 shows a diagram for representing curves of operating variables of the internal combustion engine before, during and after a mode switching in response to a negative sudden change in charging.

### DETAILED DESCRIPTION OF THE INVENTION

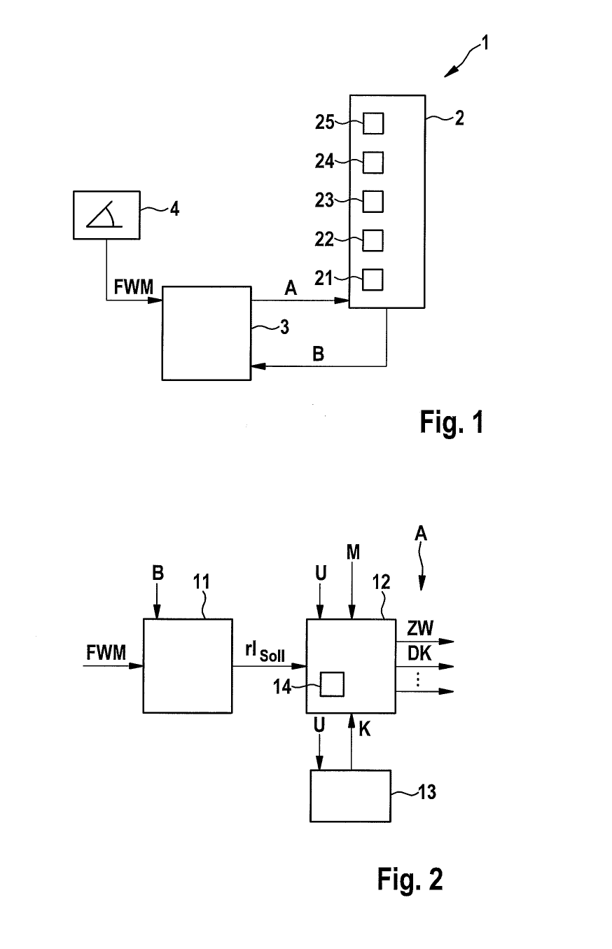

FIG. 1 shows an engine system 1 having an internal combustion engine 2 which is actuated with the aid of an engine control unit 3. Engine control unit 3 receives an instruction, via an accelerator position of an accelerator unit 4, on a driver command torque FWM, and from it it ascertains, based on operating variables B received from internal combustion engine 2, a series of actuating variables A, in order to actuate position recorders (not shown) in internal combustion engine 2.

Actuating variables A may include, for example, a throttle valve position recorder 21, ignition devices 22 for carrying out an ignition of a fuel/air mixture in cylinders (not shown) of internal combustion engine 2, a camshaft lift position recorder 23 for setting the camshaft lift, an exhaust gas recirculation valve 24 for setting the quantity of combustion exhaust gas recirculated into an air intake tract, a wastegate valve 25 for setting the performance of an exhaust gas turbocharger and the like. As operating variables B one may use the rotational speed n of internal combustion engine 2, for example, and/or the load L of internal combustion engine 2, as well as optional further operation-dependent variables.

Engine control circuit 3 is developed to provide actuating variables A corresponding to the operating point of internal combustion engine 2 and as a function of driver command torque FWM. In addition, engine control unit 3 determines points in time for mode switchings, which are undertaken, for example, for reasons of lowering the fuel consumption, for carrying out diagnostic functions, at load changes and the like.

For instance, one of the mode switchings may relate to the switching of a camshaft lift position recorder 23, in which the lifts of intake and outlet valves are varied. An increase in the lift of the intake valves, at otherwise equal operating parameters, results in a greater air charging in the cylinders, which leads directly to a positive sudden change in charging. In contrast to that, a reduction in the lift of the intake valves at otherwise equal operating parameters leads to a lower air charge in the cylinders, which corresponds to a negative sudden change in charging. For the preparation of a mode switching having a negative sudden change in charging, a charging buildup may be provided directly before the switching time.

Other mode switchings, such as cylinder shut-down, switching to a lean mode or the like may also have effects on the actual air charge in the cylinders of internal combustion engine 2 directly after the switching.

FIG. 2 shows a functional diagram which describes the operation of internal combustion engine 2 with the aid of a torque model and an adaptation. The functional diagram is described particularly with the aid of a mode switching, which provides the setting of a camshaft lift position recorder 23. In torque model block 11, as a function of the instantaneous operating point, which is indicated by the operating variables B, and as a function of a specified driver command torque FWM, a setpoint air charge rlₛₑₜₚₒᵢₙₜ is ascertained which represents the basis for ascertaining the actuating variables A for actuating internal combustion engine 2. The ascertainment setpoint air charge rlₛₑₜₚₒᵢₙₜ takes place in an actuating block 12 in a known manner by basing it on parametric characteristic maps and functions.

Based on setpoint air charge rlₛₑₜₚₒᵢₙₜ, with the aid of the provided engine rotational speed n, actuating variables A are ascertained for the position recorders of internal combustion engine 2. At a mode switching which is started or initiated by an edge of a switching signal U, if an increase of the valve lift takes place, this leads to a greater air quantity flowing into the cylinders of internal combustion engine 2, in response to the opening of the intake valve using the lift that was just increased. The result is that, in a corresponding mode switching, a sudden change occurs in the effective actual air charge in the cylinders of internal combustion engine 2. It is therefore provided in actuating block 12 to adapt the efficiency of internal combustion engine 2 by adjusting ignition angle ZW in such a way that the increased fuel supply effected by the increased air charge does not lead to a sudden change in torque. The reduction in the efficiency at a corresponding mode switching, which leads to an increased air charging, is particularly achieved by an ignition retard of ignition angle ZW.

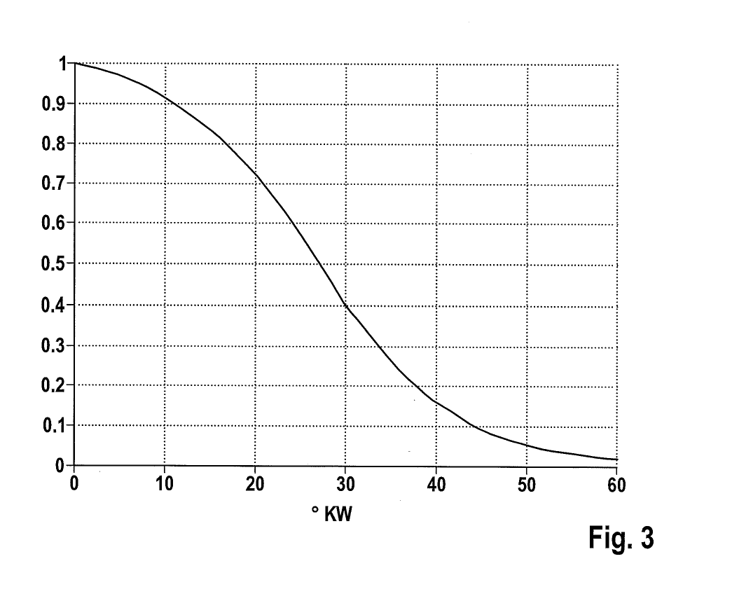

As a measure for reducing the efficiency, an efficiency characteristic curve is used, which is provided in a characteristic curve block 14 in actuating block 12 and which, for a determined operating point, indicates ignition angle efficiency η relative to the engine torque that is optimal at a certain operating point via set ignition angle ZW. The curve of this efficiency characteristic line is shown in FIG. 3, for an exemplary engine rotational speed n. The efficiency characteristic curve shown there gives the ignition angle at a variation in ignition angle ZW with respect to the optimal ignition angle.

An adaptation block 13 is also provided which provides one or more correction variables K for correcting the torque models, for instance, by a correction of the efficiency characteristic curve. Adaptation block 13 provides correction variable K in such a way that the torque model is able to be adapted dependent upon the operating point. Correction variable K provided by adaptation block 13 is used for the permanent correction of the torque model.

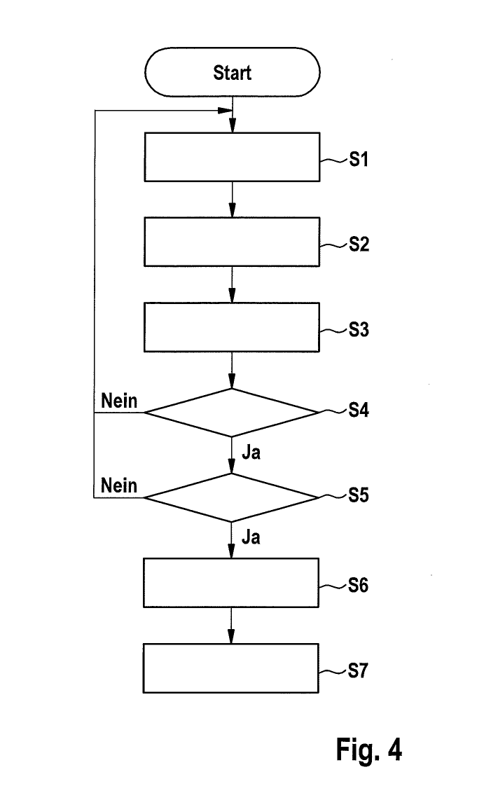

Adaptation block 13 is developed in order to become active or activated in response to a mode switching, which is signaled by switching signal U, in response to a mode switching. Adaptation block 13 adapts correction variables K for the correction of the efficiency characteristic curve, so that upon ascertainment of the ignition angle ZW, a sudden change in charging in response to a mode switching or deviations of the charging efficiency ascertained using the efficiency characteristic curve are able to be compensated for via an adaptation of the torque model. One possible method for the adaptation is shown in the flow chart in FIG. 4.

For mode switchings, adaptation block 13 becomes active and checks, by monitoring an operating variable B, such as the rotational speed n, in a first time window before the mode switching and in a second time window during and/or after the mode switching, whether, as a result of the mode switching, a change has come about in the drive torque provided by internal combustion engine 2. In particular, it is checked whether a rotational speed change has come about as a result of the mode switching.

For this purpose, in step S1, adaptation block 13 permanently records rotational speed n of internal combustion engine 2 within a certain first time window and stores the recorded rotational speed values, which indicate the curve of rotational speed n within the determined first time window, in a corresponding memory. At a point in time at which switching signal U signals a mode switching, data on the stored rotational speeds n before the mode switching are then available for evaluation. Instead of rotational speed n, one or more operating variables B may also be used, which are suitable for representing a torque curve of internal combustion engine 2.

Rotational speeds n of the first time window are analyzed in step S2 with regard to the upgrade and the noise and are predicted into the future, in order to obtain a first comparative variable. In particular, the rotational speed signal is extrapolated to the time of the mode switching, which is indicated by switching signal U, in order to obtain as first comparative variable an estimated rotational speed n at switching time TU, based on rotational speeds n and the curve of rotational speeds n in the first time window.

In the same way, in step S3, one or more rotational speeds n are recorded in a second time window after the mode switching. From the curve of the rotational speed recorded in step S3, a maximum and/or minimum rotational speed within a second time window or an average rotational speed (average value of the rotational speed) is ascertained as a, or rather several second comparative variables.

By comparing the first and second comparative variable in a checking step S4, it is able to be determined whether a sudden change in the drive torque has taken place because of mode switching. This is determined if the minimum rotational speed in the second time window as second comparative variable is smaller by more than one specified absolute deviation value than the rotational speed extrapolated through the first time window as the first comparative variable and/or if the maximum rotational speed in the second time window as second comparative variable is greater by more than a specified absolute deviation value than the rotational speed extrapolated through the first time window as the first comparative variable. If the corresponding is determined in step S4 (alternative: yes), it is checked in step S5 whether suitable environmental conditions are present, which permit an adaptation. Otherwise (alternative: no) no adaptation is undertaken and the system jumps back to step S1.

Moreover, it may be provided that the specified deviation threshold value is a function of the transmission variants used and the driving position selected, since, depending on the transmission and the driving position selected, a change in the drive energy is able to lead to different changes in rotational speed n.

The suitable environmental conditions, which permit an adaptation, are checked in step S5, in order to avoid maladaptations, which could make themselves felt as reactions by the drive train, the roadway, the driver torque command FWM and further disturbance variables that influence rotational speed n. If it is determined in step S5 that an adaptation is admissible (alternative: yes) then the method is continued with step S6. Otherwise (alternative: no) no adaptation is undertaken and the system jumps back to step S1.

The deviations between the first and the one or the two second comparative variables may be stored in step S6 in an adaptation characteristic map as a function of the operating point, and a plurality of adaptation values ascertained for one operating point may be averaged, so as to filter out undesired maladaptations. Depending on the application case, the adaptation characteristic maps may be generated as a function of the operating point, for instance, over the engine rotational speed n, the engine torque and/or the engine load.

The adaptation takes place in step S7, preferably incrementally, that is, at a deviation of the first comparative variable from the second comparative variable by more than the specified deviation threshold value. The operating point-dependent adaptation values are adapted by appropriately incrementing or decrementing the adaptation value associated with the respective operating point, namely, in correspondence with the sign of the difference between the first and the second comparative variable.

If an adaptation characteristic map is provided having the adaptation values, it may then be provided that a uniform learning of the adaptation ranges be ensured. For this purpose, in each case several adjacent characteristic map points are evaluated and, corresponding to the differences from one another, are, as a result, differently well learned, in order to achieve adaptation characteristic maps that are as uniformly homogeneous as possible, and to avoid sudden changes in the variables that have an effect on the drive torque. In the case of adjacent characteristic map points of the adaptation characteristic map, if, for example, a big difference is determined between the adaptation values, then, assuming a corresponding exceeding of the deviation threshold value by the difference between the two comparative variables, an incrementing of the higher absolute adaptation value may turn out to be less than the incrementing of the lower absolute adaptation value.

In general, in the case of two adjacent characteristic map points of the adaptation characteristic map, an incrementing or decrementing in the direction of the value of the adjacent characteristic map point may be carried out using a higher weighting than the incrementing or decrementing in a direction opposite to the direction of the value of the adjacent characteristic map point.

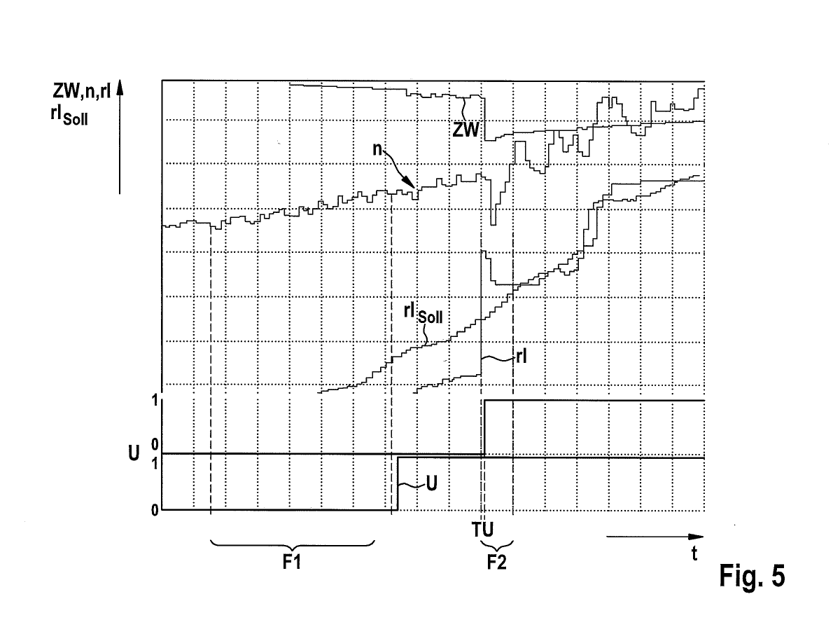

FIG. 5 shows a diagram showing curves of a rotational speed n, the air charge rl, the setpoint charging rlₛₑₜₚₒᵢₙₜ, the switching signal U and the ignition angle ZW, in each case before and after a mode switching, which has the effect of a positive sudden change in charging. Furthermore, the first time window Fl before the mode switching and the second time window F2 after the mode switching are indicated, with respect to which an evaluation of the rotational speed curves n of internal combustion engine 2 is undertaken.

Since after the mode switching, vibrations may occur on the drive train, an evaluation of the rotational signal may be problematic, under certain circumstances. For this reason, the point in time of the beginning of the second time window may be provided after a specified time period from the switching time, in order to await stabilization of the rotational speed curve. In addition, by the use of filters on the rotational speed curve in a time window F1, F2, or in both time windows, a smoothing of the corresponding signal may take place.

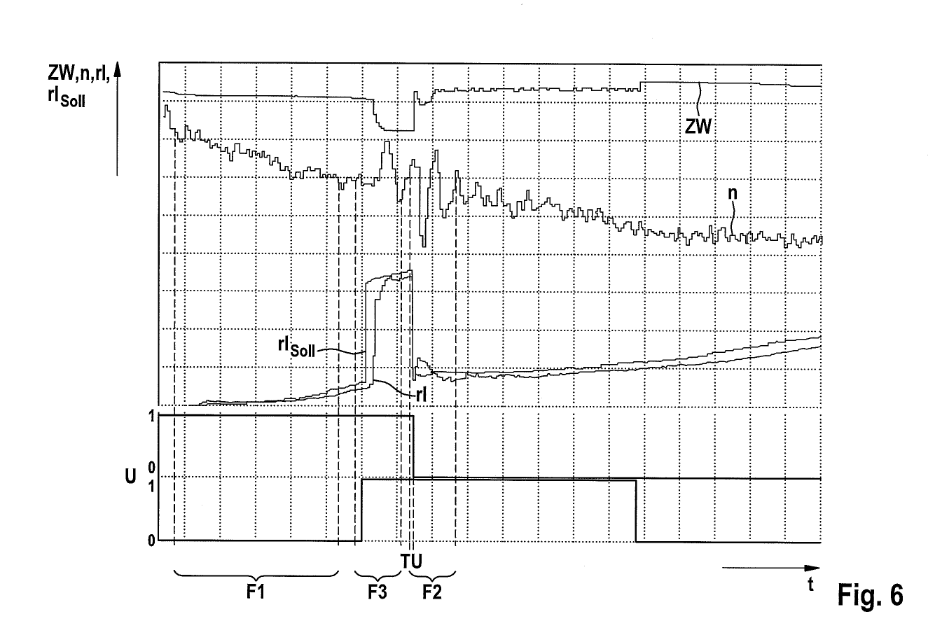

FIG. 6 shows an additional diagram showing curves of a rotational speed n, the air charge, the setpoint charging rlₛₑₜₚₒᵢₙₜ, the switching signal U and the ignition angle ZW, in each case before, during and after a mode switching, which has the effect of a negative sudden change in charging. Furthermore, the first time window F1 before the mode switching, the second time window F2 after the mode switching and a third time window F3 during a switching preparation are indicated directly before switching time TU, with respect to which an evaluation of the rotational speed curves n of internal combustion engine 2 is undertaken.

To prepare for a mode switching that has the effect of a negative sudden change in charging, as a rule, a charging increase is carried out before switching time TU. This charging increase takes place according to the torque model, in common with a compensation, particularly with the aid of the efficiency characteristic curve, so that the engine torque provided remains the same. In the sequence of FIG. 6, the charging increase takes place before the switching at a simultaneous ignition angle correction, so that, in the case of a maladaptation of the torque model, a rotational speed fluctuation is able to be established even before the switching. For this purpose, the rotational speed is evaluated in the third time window F3 in a manner corresponding to the above method and an adaptation is carried out if necessary.

Furthermore, at switching time TU, there takes place a sudden change in charging reduction, which also has to be corrected by the torque model. A maladaptation is able to be detected by evaluating the rotational speed and the curve of the rotational speed in second time window F2, corresponding to the above method, and the corresponding correction variable is able to be adapted.

What is claimed is:

1. A method for adapting a torque model for operating an internal combustion engine, wherein the torque model indicates an ignition angle adjustment as a function of an air charge in a cylinder of the internal combustion engine, the method comprising;
adapting the torque model based on a variation of an operating variable of the internal combustion engine caused by a mode switching.

2. The method as recited in claim 1, wherein:
the torque model is calculated with the aid of an efficiency characteristic curve;
the efficiency characteristic curve is adaptable with the aid of a correction variable;
the correction variable is one of determined or adjusted based on (i) a curve of the operating variable of the internal combustion engine in a first time period before a mode switching and (ii) a curve of the operating variable of the internal combustion engine in a further time period at least one of during and after the mode switching.

3. The method as recited in claim 2, wherein the correction variable, as a function of the operating point, acts upon one of an offset, an upgrade or individual characteristic map points of the efficiency characteristic curve of the torque model.

4. The method as recited in claim 2, wherein the operating variable corresponds to one of a rotational speed of the internal combustion engine, a rotational speed gradient of the internal combustion engine, or a measure of the slipping of an automatic transmission of the internal combustion engine.

5. The method as recited in claim 4, wherein, by extrapolation of the curve of the operating variable of the internal combustion engine, a first comparative variable is determined in the first time period at the switching time of the switching of the mode, and a second comparative variable is determined from the curve of the operating variable of the internal combustion engine in the further time period as at least one of the maximum, the minimum and the average value of the operating variable in the further time period, the correction variable being one of determined or adapted based on the first and the second comparative variable.

6. The method as recited in claim 5, wherein the adaptation of the correction variable is carried out with respect to the operating point, during the mode switching, as a function of whether a comparative variable difference between the first comparative variable and the second comparative variable exceeds a specified absolute value of the deviation.

7. The method as recited in claim 6, wherein the correction variable is one of incremented or decremented, with respect to the operating point, as a function of the comparative variable difference by one of a constant value or a value which is a function of the comparative variable difference.

8. The method as recited in claim 6, wherein an operating point-dependent adaptation characteristic map is provided, and wherein the operating point-dependent adaptation characteristic map is updated using the determined comparative variable difference at a certain operating point, by changing the values previously recorded and assigned to the determined operating point of the comparative variable differences as a function of the determined comparative variable difference at the certain operating point, by updating the characteristic map point assigned to the certain operating point using a value which is yielded by the current value of the comparative variable difference at the certain operating point and the up-to-the-present value at the characteristic map point, the correction variable which is a function of the operating point being determined as a function of the respective characteristic map point of the adaptation characteristic map.

9. The method as recited in claim 5, wherein the mode switching corresponds to a switching between two operating modes which effects a charging change, both operating modes providing the adaptation of an efficiency by the adaptation of the ignition angle.

10. A device for adapting a torque model for operating an internal combustion engine, wherein the torque model indicates an ignition angle adjustment as a function of an air charge in a cylinder of the internal combustion engine, the control unit comprising:
a control unit including a processor configured to adapt the torque model based on a variation of an operating variable of the internal combustion engine caused by a mode switching.

11. A non-transitory, computer-readable data storage medium storing a computer program having program codes which, when executed on a computer, performs a method for adapting a torque model for operating an internal combustion engine, wherein the torque model indicates an ignition angle adjustment as a function of an air charge in a cylinder of the internal combustion engine, the method comprising;
adapting the torque model based on a variation of an operating variable of the internal combustion engine caused by a mode switching.
